(19) United States
(12) Patent Application Publication
(10) Pub. No.: US 2008/0260216 A1
(43) Pub. Date: Oct. 23, 2008

(54) Method for Encrypting and Identifying Fingerprint Image in Fingerprint-Identifying System

(75) Inventors: Minghe Zhang, Shanghai (CN); Yingjie Zhang, Shanghai (CN)

Correspondence Address: OSHA LIANG L.L.P., 1221 MCKINNEY STREET, SUITE 2800, HOUSTON, TX, 77010, US

(73) Assignee: Minghe Zhang, Shanghai (unknown)

(21) Appl. No.: 12/067,163

(22) PCT Filed: Nov. 3, 2005
(86) PCT No.: PCT/CN05/01836

§ 371 Date: Mar. 17, 2008

(30) Foreign Application Priority Data
Sep. 16, 2005 (CN) 200510029716.5

(51) Int. Cl. G06K 9/00

(52) U.S. Cl. 382/124

(57) ABSTRACT

A method for fingerprint image encryption and recognition in the fingerprint recognition system includes: inputting a characteristic fingerprint image through a fingerprint acquisition device of the said system by a user as per a selected angle of imaging; extracting characteristic data from said characteristic fingerprint image; and storing said characteristic data in a form of data module to complete the encryption of the fingerprint image. A method of the present invention may change the data information of existing individual fingerprint characteristics by changing the angle of imaging when a fingerprint is input into the system so that the fingerprint image can be encrypted. Thus, the adverse consequences of a stolen fingerprint image can be avoided despite of objective openness of individual fingerprints. Methods of the invention minimize the security risks and protect users' interests.

### TECHNICAL FIELD

The present invention relates to an art of biometric, especially the methods for fingerprint image encryption & recognition in the fingerprint recognition system.

### BACKGROUND

The fingerprint recognition system as per the user is classified into two types: one is a passive type, in which the fingerprints input are all used to meet certain requirements of others, e.g. suspects to criminal investigators; and the other is an active type, in which the user himself desires the recognition system to reject the unauthorized access by others, so as to guarantee the security of the user or his part.

With the rapid development of modern technology, the above-mentioned passive fingerprint recognition system has achieved substantial improvement in terms of quantity and precision of contrast. For example, the fingerprint recognition and storage system of US entry port has adopted a ten-fingerprint system for the user. However, designers of active fingerprint recognition system are only satisfied with the theoretical error rate of “millionth” for single fingerprint false rejection and have made few actions for security vulnerability existing in the technology available so far. According to the thesis of Impact of Artificial “Gummy” Fingers on Fingerprint Systems published on the internet on May 15^{th}, 2002 by Tsulomu Matsumoto & al. of Yokohama National University (Japan), it is indicated that “fake fingers” have been made from different cheap materials (e.g. glycocoll, gel and silica gel, etc.) by utilization of the residual fingerprint, which has fooled fingerprint recognition systems configured with capacitance and hardness transducer and proved to be an adverse challenge for the existing technology.

Obviously for the active user, there are great security risks in the fingerprint system with existing technology. This is because the fingerprint of any individual, to some extent, is exposed and open in real life and is a private image with no protection via encryption.

Moreover, few effective measures have been made and corresponding configurations adopted in the commercial recognition system available now to avoid the existent security vulnerability mentioned above.

Nowadays, a few manufacturers have realized the existence of security vulnerability through the invasion of “fake fingers” into the fingerprint recognition system with no fingerprint image encryption and further launched so-called “double control” products, i.e. fingerprint image plus a numerical password. However, the emergence of “double control” products is equal to declare that the recognition system for the active user has come to an end. In fact, the expected “security” effect has not been achieved by adding a numerical password: even for the pocket decoder with lower operational speed, the conventional numerical ciphers can only survive for one or two minutes at most.

Therefore, how to exert the real “double control” effect of fingerprint recognition system through the encryption of fingerprint image and to maintain the less than millionth false acceptance rate for “false rejection” in a single fingerprint recognition system is one of the problems that the Applicant devotes to research.

### SUMMARY OF THE INVENTION

It is an objective of this invention to provide a method for fingerprint image encryption & recognition in the fingerprint recognition system, so that the adverse consequences for the stolen fingerprint image can be avoided despite of the objective openness of individual fingerprint and the security risks can be eliminated while ensuring the existing false acceptance rate of “false rejection” for the active fingerprint recognition system.

In this invention, an encryption method for fingerprint image in the fingerprint recognition system includes: input: the characteristic fingerprint image is input through the fingerprint acquisition device of the said system by the user as per the selected angle of imaging; extraction: the said characteristic fingerprint image generated is calculated to extract the characteristic data; storage: the said characteristic data are stored in the form of data module so as to complete the encryption of fingerprint image. Furthermore:

The corresponding recognition method for the said encryption method is provided by this invention, which includes: input: the characteristic fingerprint image is input at the angle visually estimated by the user; extraction: the said characteristic fingerprint image generated is calculated to extract the characteristic data; verification: a fuzzy contrast is made between the said characteristic data extracted and the stored data module to identify the genuine and the false.

Another encryption method for fingerprint image in the fingerprint recognition system is provided by this invention, including: input: the characteristic fingerprint image is input through the fingerprint acquisition device of the said system by the user as per the selected angle of imaging; determination and display: the said system determines the actual angle and displays; extraction: the said characteristic fingerprint image generated is calculated to extract the characteristic data; storage: the said characteristic data are stored in the form of data module to complete the encryption of fingerprint image. Furthermore:

The corresponding recognition method for the said encryption method is also provided by this invention, which includes: preliminary contrast: a preliminary fuzzy contrast is made between the characteristic data extracted from the characteristic fingerprint image input by the user at the angle visually estimated and the data module of characteristic fingerprint image stored in the system; prompt for input: if the contrast results are basically accordant, the system shall prompt to input angle data for imaging of fingerprint; confirmation and verification: after the system has confirmed and recognized that the input data by the user are correct, it shall automatically and precisely rotate the input fingerprint image to the required angle according to the angle-data command; then, the system shall extract more characteristic data this time from the fingerprint image and make a fuzzy contrast with the stored data module to accurately identify the genuine and the false.

With the above-mentioned technical solution, this invention changes the data information of the existing individual fingerprint characteristics by adjusting the angle of imaging when fingerprint is input into the system, so that the fingerprint image can be encrypted. Thus, the adverse consequences for the stolen fingerprint image can be avoided despite of the objective openness of individual fingerprint. While ensuring the existing false acceptance rate of “false rejection” for active fingerprint recognition system, the present invention eliminates the security risks to guarantee the interests of the user or his part.

### DESCRIPTION OF THE PREFERRED EMBODIMENTS

This invention is conceived from the following thoughts:

There is always a format to determine the individual characteristics (such as direction, opening, left whorl, right loop, etc.) of fingerprint image, that is, in the directions when the fingertips are upwards or forwards, in other words, when the fingers are placed along the axis y while the fingertips are upwards or forwards and the fingerprint core is on the origin. It is also the design principle of the existing fingerprint recognition system to regard the fingerprint characteristics as invariable.

However, the fact is not like that. As a geometric figure, the fingerprint image shall possess its inherent geometric properties: when the angle of imaging for fingerprint in 2-dimensional space is changed, totally different characteristic data shall be obtained for the same fingerprint, and even the existing left-right and up-down orientations shall be reversed; thus, when the genuine finger is deflected by a certain angle accidentally, the embarrassment of “genuine rejection” shall also be suffered for the recognition system with the existing technology. In fact, this implies that the fingerprint image can be encrypted in a simplest but substantial geometric approach, or by recovering the inherent geometric properties of fingerprint image, that is, using the characteristic data extracted from the fingerprint image randomly input at a certain angle as data module for contrast in the system, so as to constitute a “fingerprint password” in a real sense.

Thus, even if “fake fingers” look genuine, or so much as “genuine fingers” with the very elements of the fingerprint password have been obtained, it also does not mean that the “fingerprint password” has been learnt. This is just like when we all have the constitutional elements of a numerical cipher, such as 0, 1, 2, 3 . . . and 9, we still have no idea what the cipher encoded randomly by others is. What's more, since digital conversion technology in a single direction is adopted by all fingerprint systems, it is impossible to reversely reproduce the original fingerprint image through the modularized characteristic data that are generated and stored. Thus, nothing can be done to decode the fingerprint password because it is also impossible to unscramble which user or which one or more fingerprints have been encrypted into the recognition system. Undoubtedly, the fingerprint image encryption by geometric approach has fundamentally enhanced the security performance of the existing recognition system.

Thus, the two following methods can be adopted for fingerprint image encryption in this invention.

1. (a) Encryption by Visual Estimation

It means that the characteristic fingerprint image, generated by selecting a certain angle of imaging by the user through visual estimation on the fingerprint acquisition device of the fingerprint recognition system, is calculated by the system to obtain characteristic data, which are then stored as data module of the system, i.e. the encryption method by fingerprint password.

(b) Recognition of Encryption by Visual Estimation

When the system is required for recognition, the user shall make a visual estimation and input the fingerprint password at the angle of imaging. Then the system calculates immediately the characteristic fingerprint image generated to extract characteristic data of fingerprint, and conducts a contrast between the characteristic data and the stored data module to identify the genuine and the false. Otherwise, even the genuine finger shall not be qualified.

The reason why encryption and recognition by visual estimation is exercisable is that fuzzy calculation method is adopted for extraction and contrast of fingerprint characteristic data, and thus certain deflection and translation errors are allowed when fingerprint is input into the system. Actually, the fingerprint input with existing technology all adopts visual estimation method with no exception. If the angle input through visual estimation with existing technology is placed in the 2-dimensional space for identification, it shall be around 90°. Therefore, it is expressly indicated in descriptions of fingerprint lock of an American company that deflection tolerance of 15° and translation tolerance of ±3 mm are allowed.

2. (a) Encryption by Data Method

It means that characteristic fingerprint image is input at a random angle by the user, the data of characteristic fingerprint at the actual angle of imaging are determined and displayed by the system and then the characteristic data obtained from calculation of characteristic fingerprint image are stored as data module of the system, thus constituting the fingerprint password of the user. This kind of encryption method by displaying fingerprint imaging data in the course of inputting is called data method.

(b) Recognition of Encryption by Data Method

When the system is required for recognition, the user shall firstly make a visual estimation and input the characteristic fingerprint image at the angle of imaging of fingerprint password; the system extracts the characteristic data for a preliminary contrast between the characteristic data and the stored data module of characteristic fingerprint image, and then prompts to input the data concerned with the angle of fingerprint imaging if the contrast results are accordant. This data shall be used as access password and operational command of the system. After the user's input and confirmation of the data, and the data are recognized by the system, it shall automatically and precisely rotate the input fingerprint image to the required angle according to the angle-data command. Then, the system will extract more characteristic data of fingerprint image this time and make fuzzy contrasts with the stored data module in order to accurately identify the genuine and the false.

Since the present invention makes some changes to the method that fingerprint image is input at an invariable angle based on the existing technology, the former classification algorithm of fingerprint data shall be updated accordingly. Among many algorithms, the one that combines coordinates of direction information and fingerprint minutiae is preferred to precisely indicate different data of the uniqueness of fingerprint as shown in different angles and positions in the 2-dimensional space. It is self-evident that the data information of the uniqueness of fingerprint shall show a series of objective changes in accordance with the subjective changes of the angle of fingerprint imaging by the user. This fact has laid a sound scientific basis for the method of encryption and recognition of fingerprint image with geometric approach.

For the two methods of encryption and corresponding recognition mentioned above, the modes of single or multi-fingerprint can be selected according to the requirements for security levels of the recognition system.

When using the method of this invention for encryption, the window of fingerprint acquisition device shall be round in shape rather than being oval or rectangular as in the existing technology, so that a complete fingerprint image shall be input from all directions by the user; meanwhile, the redundant image information at the lower part of fingerprint at or adjacent to such positions as 45°, 135°, 225° and 315° shall be shielded to improve the handling efficiency of the system. Besides, the simple input operation within the range of 0°→360° by the user shall be facilitated by marking points at a certain angle along the circumference for reference.

To sum up, the secure and reliable characteristics of this invention lie in that: even if criminals have obtained the user's “genuine fingers” that possess the elements of fingerprint password, it does not mean that they have learnt all the “fingerprint password”, because the data information about the angle of imaging selected by the user shall be possessed at the same time. Therefore, compared with the recognition system of existing technology that is accessed by fingerprint information from the active user under no protection of encryption, the security performance of the system with encryption by fingerprint image in this invention is unparalleled.

Although this invention is detailed in combination with preferred embodiments, the technicians in the field can make variations to this invention on the basis of these descriptions. Thus, some details in the preferred embodiments shall not form restrictions to this invention. The scope defined in the attached Claims shall be adopted as the protection scope of this invention.

1. An encryption method for fingerprint image in the fingerprint recognition system, includes:
Input: the characteristic fingerprint image is input through the a fingerprint acquisition device of the said system by the a user as per the
Extraction: the said characteristic fingerprint image generated is calculated to extract the characteristic data;
Storage: the said characteristic data are stored in the form of data module so as to complete the encryption of fingerprint image.

2. According to claim 1, the encryption method is characterized in that: the said calculation adopts the algorithm combining the coordinates of fingerprint direction information and fingerprint minutiae, to precisely indicate all data of the uniqueness of fingerprint as shown in different angles and positions in the 2-dimensional space.

3. According to claim 1, the encryption method is characterized in that: the modes of single or multi-fingerprint can be selected according to the requirements for security levels of the recognition system.

4. According to claim 1, the encryption method is characterized in that: the window of the said fingerprint acquisition device is round in shape, so that a complete and symmetrical fingerprint image shall be input from all directions by the user.

5. A recognition method for fingerprint after encryption according to claim 1 in fingerprint recognition system is characterized in that:
Input: the characteristic fingerprint image is input at the angle visually estimated by the user;
Extraction: the said characteristic fingerprint image generated is calculated to extract the characteristic data;
Verification: a fuzzy contrast is made between the said characteristic data extracted and the stored data module to identify the genuine and the false.

6. An encryption method for fingerprint image in the fingerprint recognition system, includes:
Input: the characteristic fingerprint image is input through the fingerprint acquisition device of the said system by the user as per the selected angle of imaging;
Determination and display: data of the actual angle for imaging of the said characteristic fingerprint are determined by the said system and displayed.
Extraction: the said characteristic fingerprint image is calculated to extract the characteristic data;
Storage: the fingerprint characteristic data at the angle of imaging are stored as data module to complete the encryption of fingerprint image.

7. According to claim 6, the encryption method is characterized in that: the window of the said fingerprint acquisition device is round in shape, so that a complete and symmetrical fingerprint image can be input from all directions by the user.

8. According to claim 6, the encryption method is characterized in that: the modes of single or multi-fingerprint can be selected according to the requirements for security levels of the recognition system.

9. A recognition method for fingerprint after encryption according to claim 6 in the fingerprint recognition system, includes:
Preliminary contrast: a preliminary fuzzy contrast is made between the characteristic data extracted from the characteristic fingerprint image input by the user at the angle visually estimated and the data module of characteristic fingerprint image stored in the system;
Prompt for input: if the contrast results are basically accordant, the system shall prompt to input the angle data for imaging of fingerprint;
Confirmation and verification: after the system has confirmed and recognized that the input data by the user are correct, it shall automatically and precisely rotate the input fingerprint image to the required angle according to the angle-data command. Then, the system shall extract more characteristic data this time from the fingerprint image and make a fuzzy contrast with the stored data module to accurately identify the genuine and the false.

10. According to claim 9, the recognition method is characterized in that: the said actual angle data are also used as access password and operational command of the system.

11. According to claim 7, the encryption method is characterized in that: the modes of single or multi-fingerprint can be selected according to the requirements for security levels of the recognition system.
